(19) United States
(12) Patent Application Publication
(10) Pub. No.: US 2022/0210585 A1
(43) Pub. Date: Jun. 30, 2022

(54) ACOUSTIC ELEMENT

(71) Applicant: STARKEY LABORATORIES, INC., Eden Prairie, MN (US)

(72) Inventors: Thomas Burns, St. Louis Park, MN (US); Michael Karl Sacha, Chanhassen, MN (US); Ross Wilhelm, Eden Prairie, MN (US); Westley G. Gentry, Buffalo, MN (US)

(21) Appl. No.: 17/563,601

(22) Filed: Dec. 28, 2021

Related U.S. Application Data
(60) Provisional application No. 63/131,367, filed on Dec. 29, 2020.

(51) Int. Cl. H04R 25/00

(52) U.S. Cl. CPC H04R 25/658; H04R 25/604

(57) ABSTRACT

A hearing device may include a housing, a microphone, and an acoustic element. The housing may include a shell and a microphone port disposed between an outer surface of the shell and an inner surface of the shell that defines a cavity within the shell. The microphone may be disposed within the cavity of the shell and acoustically connected to the microphone port. The acoustic element may be disposed on the outer surface of the shell or at least partially within the microphone port. The acoustic element may include a substrate and fibers extending from the substrate. At least a portion of acoustic energy incident upon the acoustic element may be received by the microphone.

### BACKGROUND

Hearing devices, such as hearing aids, can be used to transmit sounds to one or both ear canals of a wearer. Some hearing devices can include electronic components disposed within a housing that is placed in a cleft region that resides between an ear and the skull of the wearer. Such housings typically can be connected to an earpiece that is disposed in an ear canal of the ear of the wearer. Some hearing devices can include electronic components disposed within a custom molded housing that resides in the ear canal of the wearer. Earpieces and custom molded housings may include microphones and microphone ports. Hearing devices may be subject to wind generated microphone noise due to turbulent airflow that impinges on microphone ports.

### SUMMARY

In general, the present disclosure provides various embodiments of an acoustic element disposed on an outer surface of a hearing device or partially within an acoustic port of the hearing device. At least a portion of acoustic energy incident upon the acoustic element may be received by a microphone of the hearing device.

In one aspect, the present disclosure provides a hearing device that includes a housing, a microphone, and an acoustic element. The housing may include a shell and a microphone port disposed between an outer surface of the shell and an inner surface of the shell that defines a cavity within the shell. The microphone may be disposed within the cavity of the shell and acoustically connected to the microphone port. The acoustic element may be disposed on the outer surface of the shell or at least partially within the microphone port. The acoustic element may include a substrate and fibers extending from the substrate. At least a portion of acoustic energy incident upon the acoustic element may be received by the microphone.

In another aspect, the present disclosure provides a method that includes forming a housing that includes a shell and a microphone port disposed between an outer surface of the shell and an inner surface of the shell. The inner surface of the shell may define a cavity within the shell. The method may further include forming an acoustic element that includes a substrate and fibers extending from the substrate, and disposing the acoustic element on the outer surface of the shell or at least partially within the microphone port such that at least a portion of acoustic energy incident upon the acoustic element is received by the microphone.

### BRIEF DESCRIPTION OF THE DRAWINGS

Throughout the specification, reference is made to the appended drawings, where like reference numerals designate like elements, and wherein:

FIG. 1A is a schematic system block diagram of a hearing device;

FIG. 1B is a schematic system block diagram of two hearing devices configured to use in, on, or about left and right ears of a user;

FIG. 2A is a schematic partial top-down view of a hearing device including an acoustic element;

FIG. 2B is a schematic partial cross-section view of the hearing device FIG. 2A;

FIG. 3A is a schematic partial top-down view of another hearing device including an acoustic element;

FIG. 3B is a schematic partial cross-section view of the hearing device of FIG. 3A;

FIG. 4 is a schematic partial cross-section view of another hearing device including an acoustic element; and

FIG. 5 is a schematic flow diagram of an illustrative technique, or process, for making an acoustic element.

### DETAILED DESCRIPTION

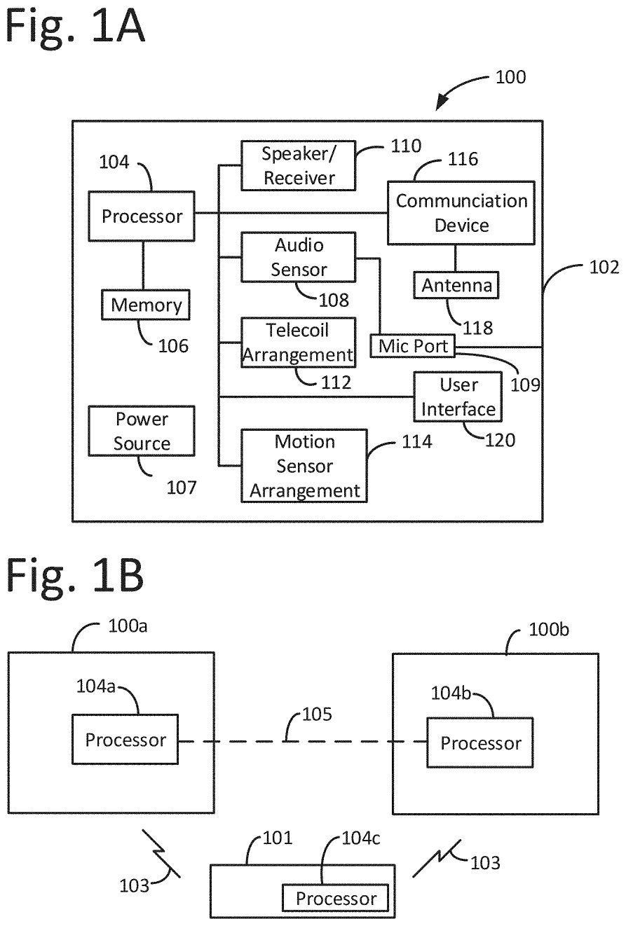

Exemplary techniques, apparatus, and systems shall be described with reference to FIGS. 1A, 1B, 2A, 2B, 3A, 3B, 4, and 5. It will be apparent to one skilled in the art that elements or processes from one embodiment may be used in combination with elements or processes of the other embodiments, and that the possible embodiments of such techniques, apparatus, and systems using combinations of features set forth herein is not limited to the specific embodiments shown in the Figures and/or described herein. Further, it will be recognized that the embodiments described herein may include many elements that are not necessarily shown to scale. Still further, it will be recognized that timing of the processes and the size and shape of various elements herein may be modified but still fall within the scope of the present disclosure, although certain timings, one or more shapes and/or sizes, or types of elements, may be advantageous over others.

In general, the present disclosure describes various embodiments of acoustic elements that may reduce turbulent airflow near microphone ports. The disclosure herein will use the term “microphone port” and “acoustic energy.” It is to be understood as used herein that a “microphone port” can include any hole, cavity, depression, and/or groove that provides a pathway for sound to travel from the environment to a microphone disposed in the housing of a hearing device. It is to be understood as used herein that “acoustic energy” can include any disturbance of energy that passes through matter in the form of a wave. In other words, acoustic energy may be vibrational energy that is capable of being detected by human organs of hearing.

The disclosure is defined in the claims. However, below there is provided a non-exhaustive list of non-limiting examples. Any one or more of the features of these examples may be combined with any one or more features of another example, embodiment, or aspect described herein.

Example Ex1: A hearing device that includes a housing, a microphone, and an acoustic element. The housing may include a shell and a microphone port disposed between an outer surface of the shell and an inner surface of the shell that defines a cavity within the shell. The microphone may be disposed within the cavity of the shell and acoustically connected to the microphone port. The acoustic element may be disposed on the outer surface of the shell or at least partially within the microphone port. The acoustic element may include a substrate and fibers extending from the substrate. At least a portion of acoustic energy incident upon the acoustic element may be received by the microphone.

Example Ex2: The hearing device of example Ex1, where the acoustic element is disposed adjacent to the microphone port.

Example Ex3: The hearing device of example Ex1, where the acoustic element is disposed over the microphone port.

Example Ex4: The hearing device of example Ex3, where the acoustic element occludes the microphone port.

Example Ex5: The hearing device of any one of examples Ex1-Ex4, where at least one fiber of the fibers of the acoustic element includes an aspect ratio of at least 100:1.

Example Ex6: The hearing device of any one of examples Ex1-Ex5, where the acoustic element further includes at least one opening disposed through the substrate.

Example Ex7: The hearing device of any one of examples Ex1-Ex6, where the acoustic element includes a 3D printed acoustic element.

Example Ex8: The hearing device of any one of examples Ex1-Ex7, where the housing further includes a custom molded portion.

Example Ex9: The hearing device of any one of examples Ex1-Ex8, where at least one fiber of the fibers of the acoustic element is connected to the substrate at both ends of the fiber.

Example Ex10: The hearing device of any one of examples Ex1-Ex9, where the acoustic element includes a melt-processable thermoset polymer material.

Example Ex11: The hearing device of example Ex10, where the acoustic element includes an elastomer material.

Example Ex12: The hearing device of any one of examples Ex1-Ex9, where the acoustic element includes a viscoelastic material.

Example Ex13: The hearing device of any one of examples Ex1-Ex9, where the acoustic element includes a non-Newtonian material.

Example Ex14: The hearing device of any one of examples Ex1-Ex13, where the acoustic element is disposed at least partially within the microphone port.

Example Ex15: The hearing device of any one of examples Ex1-Ex14, where the substrate of the acoustic element includes a first material and the fibers of the acoustic element comprise a second material.

Example Ex16: The hearing device of example Ex15, where a hardness value of the first material is greater than a hardness value of the second material.

Example Ex17: A method that includes forming a housing that includes a shell and a microphone port disposed between an outer surface of the shell and an inner surface of the shell. The inner surface of the shell may define a cavity within the shell. The method may further include forming an acoustic element that includes a substrate and fibers extending from the substrate, and disposing the acoustic element on the outer surface of the shell or at least partially within the microphone port such that at least a portion of acoustic energy incident upon the acoustic element is received by the microphone.

Example Ex18: The method of example Ex17, where disposing the acoustic element includes disposing the acoustic element over the microphone port.

Example Ex19: The method of example Ex17, where disposing the acoustic element includes disposing the acoustic element within the microphone port.

Example Ex20: The method of example Ex17, where disposing the acoustic element includes disposing the acoustic element on the outer surface of the housing adjacent the microphone port.

Example Ex21: The method of any one of examples Ex17-Ex20, where forming the acoustic element includes 3D printing the acoustic element.

Example Ex22: The method of example Ex21, where 3D printing the acoustic element includes 3D printing the fibers onto the substrate.

Example Ex23: The method of example Ex21, where 3D printing the acoustic element includes 3D printing the fibers and the substrate as a unitary element.

Example Ex24: The method of example Ex21, where 3D printing the acoustic element includes 3D printing the substrate using a first material and 3D printing the fibers onto the substrate using a second material.

Example Ex25: The method of example Ex21, where disposing the acoustic element includes 3D printing the acoustic element on the outer surface of the shell or at least partially within the microphone port.

An exemplary schematic block diagram of a hearing device 100 is shown in FIG. 1A. The hearing device 100 shown in FIG. 1A can represent a single hearing device 100 configured for monaural or single-ear operation or one of a pair of hearing devices 100a and 100b configured for binaural or dual-ear operation (e.g., FIG. 1B). The hearing device 100 shown in FIG. 1A includes a housing 102 within or on which various components are situated or supported.

The housing 102 may include a shell and a microphone port disposed between an outer surface of the shell and an inner surface of the shell that defines a cavity within the shell. The shell may include any suitable material or materials, for example, plastic, resin, acrylic, silicone, vinyl, polyethylene, nylon, etc. The shell may be any suitable size or shape, for example, a crescent shape to fit a cleft region that resides between an ear and a skull of the wearer or custom molded to fit inside the wearer's ear. A microphone port 109 may provide an acoustic path to allow acoustic energy from outside the housing 102 to reach the cavity or a microphone within the cavity.

The hearing device 100 may include a processor 104 (also processor 104a of hearing device 100a and processor 104b of hearing device 100b of FIG. 1B) operatively coupled to memory 106. The processor 104 can be implemented as one or more of a multi-core processor, a digital signal processor (DSP), a microprocessor, a programmable controller, a general-purpose computer, a special-purpose computer, a hardware controller, a software controller, a combined hardware and software device, such as a programmable logic controller, and a programmable logic device (e.g., FPGA, ASIC). The processor 104 can include or be operatively coupled to memory 106, such as RAM, SRAM, ROM, or flash memory. In some embodiments, processing can be offloaded or shared between the processor 104 and a processor of a peripheral or accessory device such as processor 104c of accessory device 101 of FIG. 1B. The processor 104c can communicate with hearing devices 100a, 100b using any suitable technique. In one or more embodiments, the processor 104c can communicate with hearing devices 100a, 100b utilizing electromagnetic energy 103. Further, in embodiments that include two hearing devices 100a, 100b, such devices can communicate with each other utilizing any suitable technique along wireless link 105.

An audio sensor or microphone arrangement 108 may be operatively coupled to the processor 104. The audio sensor 108 can include one or more discrete microphones or a microphone array(s) (e.g., configured for microphone array beamforming). Each of the microphones of the audio sensor 108 can be situated at different locations of the housing 102. It is understood that the term microphone used herein can refer to a single microphone or multiple microphones unless specified otherwise. The microphones of the audio sensor 108 can be any microphone type. In some embodiments, the microphones are omnidirectional microphones. In other embodiments, the microphones are directional microphones. In further embodiments, the microphones are a combination of one or more omnidirectional microphones and one or more directional microphones. One, some, or all of the microphones can be microphones having a cardioid, hypercardioid, supercardioid, or lobar pattern, for example. One, some, or all of the microphones can be multi-directional microphones, such as bidirectional microphones. One, some, or all of the microphones can have variable directionality, allowing for real-time selection between omnidirectional and directional patterns (e.g., selecting between omni, cardioid, and shotgun patterns). In some embodiments, the polar pattern(s) of one or more microphones of the audio sensor 108 can vary depending on the frequency range (e.g., low frequencies remain in an omnidirectional pattern while high frequencies are in a directional pattern).

Depending on the hearing device implementation, different microphone technologies can be used. For example, the hearing device 100 can incorporate any of the following microphone technology types (or combination of types): MEMS (micro-electromechanical system) microphones (e.g., capacitive, piezoelectric MEMS microphones), moving coil/dynamic microphones, condenser microphones, electret microphones, ribbon microphones, crystal/ceramic microphones (e.g., piezoelectric microphones), boundary microphones, PZM (pressure zone microphone) microphones, and carbon microphones.

A telecoil arrangement 112 is operatively coupled to the processor 104, and includes one or more (e.g., 1, 2, 3, or 4) telecoils. It is understood that the term telecoil used herein can refer to a single telecoil or magnetic sensor or multiple telecoils or magnetic sensors unless specified otherwise. Also, the term telecoil can refer to an active (powered) telecoil or a passive telecoil (which only transforms received magnetic field energy). The telecoils of the telecoil arrangement 112 can be positioned within the housing 102 at different angular orientations. The hearing device 100 includes a speaker or a receiver 110 capable of transmitting sound from the hearing device 100 to the user's ear drum. A power source 107 provides power for the various components of the hearing device 100. The power source 107 can include a rechargeable battery (e.g., lithium-ion battery), a conventional battery, and/or a supercapacitor arrangement.

The hearing device 100 may include a motion sensor arrangement 114. The motion sensor arrangement 114 includes one or more sensors configured to sense motion and/or a position of the user of the hearing device 100. The motion sensor arrangement 114 can comprise one or more of an inertial measurement unit or IMU, an accelerometer(s), a gyroscope(s), a nine-axis sensor, a magnetometer(s) (e.g., a compass), and a GPS sensor. The IMU can be of a type disclosed in commonly owned U.S. Pat. No. 9,848,273, which is incorporated herein by reference. In some embodiments, the motion sensor arrangement 114 can comprise two microphones of the hearing device 100 (e.g., microphones of left and right hearing devices 100) and software code executed by the processor 104 to serve as altimeters or barometers. The processor 104 can be configured to compare small changes in altitude/barometric pressure using microphone signals to determine orientation (e.g., angular position) of the hearing device 100. For example, the processor 104 can be configured to sense the angular position of the hearing device 100 by processing microphone signals to detect changes in altitude or barometric pressure between microphones of the audio sensor 108.

The hearing device 100 may incorporate an antenna 118 operatively coupled to a communication device 116, such as a high-frequency radio (e.g., a 2.4 GHz radio). The radio(s) of the communication device 116 can conform to an IEEE 802.11 (e.g., WiFi®) or Bluetooth® (e.g., BLE, Bluetooth® 4. 2, 5.0, 5.1 or later) specification, for example. It is understood that the hearing device 100 can employ other radios, such as a 900 MHz radio. In addition, or alternatively, the hearing device 100 can include a near-field magnetic induction (NFMI) sensor for effecting short-range communications (e.g., ear-to-ear communications, ear-to-kiosk communications).

The antenna 118 can be any type of antenna suitable for use with a particular hearing device 100. A representative list of antennas 118 include, but are not limited to, patch antennas, planar inverted-F antennas (PIFAs), inverted-F antennas (IFAs), chip antennas, dipoles, monopoles, dipoles with capacitive-hats, monopoles with capacitive-hats, folded dipoles or monopoles, meandered dipoles or monopoles, loop antennas, Yagi-Udi antennas, log-periodic antennas, and spiral antennas. Many of these types of antenna can be implemented in the form of a flexible circuit antenna. In such embodiments, the antenna 118 is directly integrated into a circuit flex, such that the antenna 118 does not need to be soldered to a circuit that includes the communication device 116 and remaining RF components.

The hearing device 100 may include a user interface 120 operatively coupled to the processor 104. The user interface 120 is configured to receive an input from the user of the hearing device 100. The input from the user can be a touch input, a gesture input, or a voice input. The user interface 120 can include one or more of a tactile interface, a gesture interface, and a voice command interface. The tactile interface can include one or more manually actuatable switches (e.g., a push button, a toggle switch, a capacitive switch). For example, the user interface 120 can include a number of manually actuatable buttons or switches, at least one of which can be used by the user when customizing the directionality of the audio sensors 108.

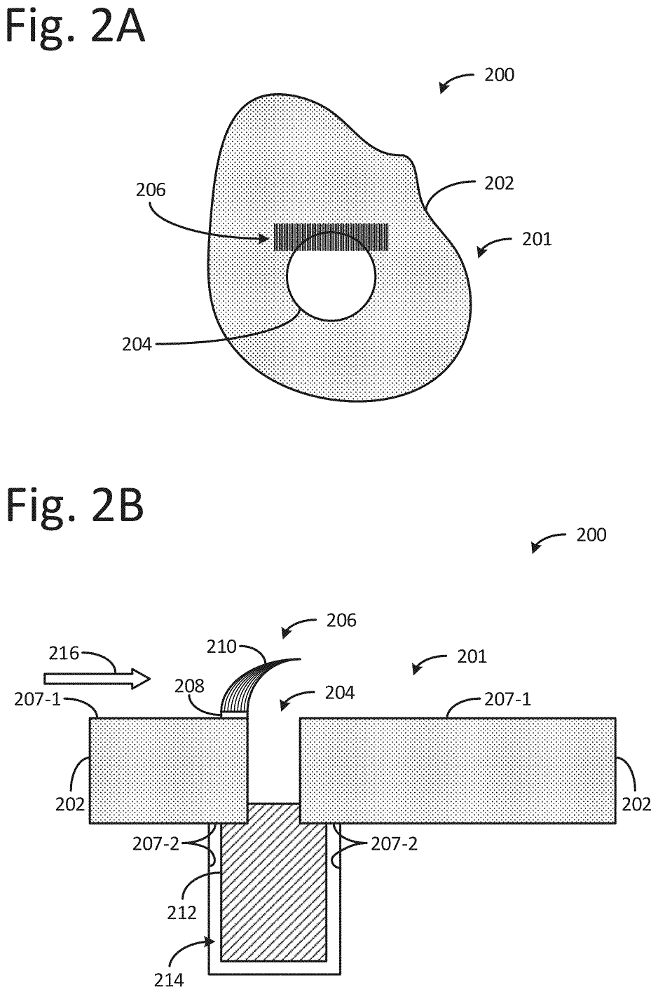

Hearing devices (e.g., hearing device 100 of FIGS. 1A and 1B) may include acoustic elements to reduce turbulent airflow that impinges on microphone ports. Various embodiments of such acoustic elements are depicted in FIGS. 2A, 2B, 3A, 3B, and 4. An exemplary schematic partial top-down view of a hearing device 200 that includes an acoustic element 206 is shown in FIG. 2A. A partial cross-sectional view of the hearing device 200 is shown in FIG. 2B. The hearing device 200 may include a housing 201 (e.g., housing 102 of FIG. 1A), a microphone 212 (e.g., audio sensor 108 of FIG. 1A), and an acoustic element 206.

The housing 201 may include a shell 202 and a microphone port 204. The shell 202 may have an outer surface 207-1 and an inner surface 207-2. The inner surface 207-2 may define a cavity 214 in the housing of the hearing device 200. The shell 202 may include any suitable material or materials such as, for example, plastic, acrylic, silicone, vinyl, polyethylene, nylon, etc. The microphone port 204 may be disposed in the shell 202 between the outer surface 207-1 and the inner surface 207-2. The microphone port 204 may acoustically connect an external environment to the cavity 214. A cross-section of the microphone port 204 may take on any suitable size or shape. The cross-section of the microphone port 204 may be, for example, circular, ovoid, polygonal, etc.

The microphone 212 may be disposed within the cavity 214 and acoustically connected to the microphone port 204. The microphone 212 may include any of the features and qualities of the audio sensor 108 of FIG. 1A. Depending on the hearing device implementation, different microphone technologies can be used. For example, the hearing device 200 can incorporate any of the following microphone technology types (or combination of types): MEMS (micro-electromechanical system) microphones (e.g., capacitive, piezoelectric MEMS microphones), moving coil/dynamic microphones, condenser microphones, electret microphones, ribbon microphones, crystal/ceramic microphones (e.g., piezoelectric microphones), boundary microphones, PZM (pressure zone microphone) microphones, and carbon microphones. The acoustic element 206 may be disposed in any suitable location.

The acoustic element 206 may be disposed on the outer surface 207-1 of the shell 202. The acoustic element 206 may be disposed adjacent to the microphone port 204. As used herein, the phrase “adjacent to” means that the acoustic element or component of the acoustic element is disposed such that at least a portion of acoustic energy that is directed toward or into the microphone port is incident upon the acoustic element. The acoustic element 206 may include any suitable material or materials. In one embodiment, the acoustic element 206 includes, for example, a melt-processable thermoset polymer material, an elastomer material, a viscoelastic material, a non-Newtonian material, etc. The acoustic element 206 may include a substrate 208 and fibers 210 extending from the substrate. The substrate 208 and the fibers 210 may be formed separately or monolithically. In one or more embodiments, the substrate 208 and fibers 210 may be formed from the same material or materials. In one or more embodiments, the substrate 208 may include a first material and the fibers 210 may include a second material. In one or more embodiments, the first material may have a hardness value greater than a hardness value of the second material.

The substrate 208 may take on any suitable size or shape. In one or more embodiments, the acoustic element 206 may include at least one opening disposed through the substrate. The substrate 208 may act as an anchor for the fibers 210. In other words, the fibers 210 may be attached to the substrate 208 and immovable at one end of each fiber while the other end of each fiber is unattached and free to move. The fibers 210 may extend over a portion of the microphone port 204. The fibers 210 may include one or more fiber like structures such as, for example, threads, filaments, tendrils, coils, spirals, etc. The fibers 210 may take on any suitable height. In one embodiment, at least one fiber of the fibers 210 of the acoustic element 206 includes an aspect ratio (height-to-width ratio) of at least 100:1.

The acoustic element 206 may mitigate turbulent air flow at or near the microphone port 204 while being substantially acoustically transparent to acoustic energy. In other words, the acoustic element 206 may mitigate wind generated microphone noise caused by turbulent air flow without substantially attenuating or distorting desired sounds such as, for example, speech, music, ambient noises, laughter, birdsong, or other acoustic energy. As shown, wind may flow in the direction of arrow 216. The acoustic element 206 may mitigate or reduce the incidence of airflow of such wind on the microphone port 204, thereby reducing turbulent air flow at or near the microphone port. However, the acoustic element 206 may not significantly reduce the amplitude of sound waves incident on the microphone port 204. In other words, at least a portion of acoustic energy incident upon the acoustic element 206 may be received by the microphone 212. Furthermore, in one or more embodiments, such acoustic energy may not be dampened or attenuated by the acoustic element.

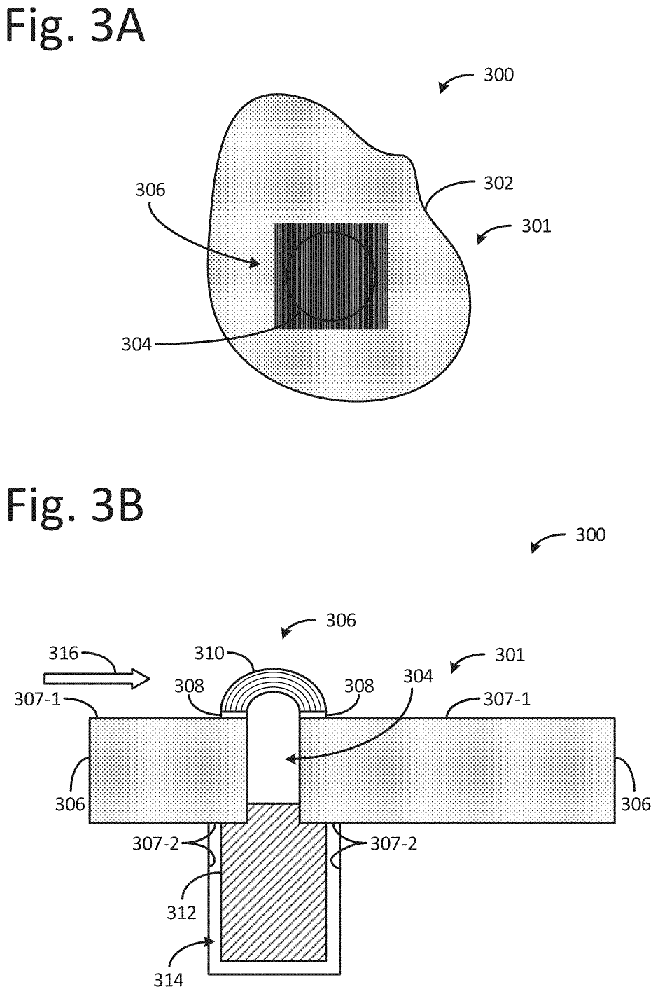

An exemplary schematic partial top-down view of a hearing device 300 that includes an acoustic element 306 is shown in FIG. 3A. A partial cross-sectional view of the hearing device 300 is shown in FIG. 3B. All of the design considerations and possibilities described herein regarding hearing device 200 of FIGS. 2A-B apply equally to hearing device 300 of FIGS. 3A-B. The hearing device 300 may include a housing 301 (e.g., housing 102 of FIG. 1A), a microphone 312 (e.g., audio sensor 108 of FIG. 1A), and an acoustic element 306.

The housing 301 may include a shell 302 and a microphone port 304. The shell 302 may have an outer surface 307-1 and an inner surface 307-2. The inner surface 307-2 may define a cavity 314 in the housing of the hearing device 300. The shell 302 may include any suitable material or materials such as, for example, plastic, acrylic, silicone, vinyl, polyethylene, nylon, etc. The microphone port 304 may be disposed in the shell 302 between the outer surface 307-1 and the inner surface 307-2. The microphone port 304 may acoustically connect an external environment to the cavity 314. A cross-section of the microphone port 304 may take on any suitable size or shape. The cross-section of the microphone port 304 may be, for example, circular, ovoid, polygonal, etc.

The microphone 312 may be disposed within the cavity 314 and acoustically connected to the microphone port 304. The microphone 312 may include any of the features and qualities of the audio sensor 108 of FIG. 1A.

The acoustic element 306 may be disposed on the outer surface 307-1 of the shell 302. The acoustic element 306 may be disposed over the microphone port 304. The acoustic element 306 may include any suitable material or materials. In one or more embodiments, the acoustic element 306 includes, for example, a melt-processable thermoset polymer material, an elastomer material, a viscoelastic material, a non-Newtonian material, etc. The acoustic element 306 may include a substrate 308 and fibers 310 extending from the substrate. The substrate 308 and the fibers 310 may be formed separately or monolithically. In one or more embodiments, the substrate 308 and fibers 310 may be formed from the same material or materials. In one or more embodiments, the substrate 308 may include a first material and the fibers 310 may include a second material. In one or more embodiments, the first material may have a hardness value greater than a hardness value of the second material.

The substrate 308 may take on any suitable size or shape. In one embodiment, the acoustic element 306 may include at least one opening disposed through the substrate. The substrate 308 may be disposed the outer surface 307-1 of the shell adjacent to the microphone port 304. Additionally, the fibers 310 may be connected to the substrate 308 at both ends such that one or more of the fibers extend over the microphone port 304. The fibers 310 may include one or more fiber like structures such as, for example, threads, filaments, tendrils, coils, spirals, etc. In one or more embodiments, at least one fiber of the fibers 310 of the acoustic element 306 includes an aspect ratio of at least 100:1.

The acoustic element 306 may mitigate turbulent air flow at or near the microphone port 304 while being substantially acoustically transparent to acoustic energy. In other words, the acoustic element 306 may mitigate wind generated microphone noise caused by turbulent air flow without substantially attenuating or distorting desired sounds such as, for example, speech, music, ambient noises, laughter, birdsong, or other acoustic energy. As shown, wind may flow in the direction of arrow 316. The acoustic element 306 may mitigate or reduce the incidence of airflow of such wind on the microphone port 304, thereby reducing turbulent air flow at or near the microphone port. However, the acoustic element 306 may not significantly reduce the amplitude of sound waves incident on the microphone port 304. In other words, at least a portion of acoustic energy incident upon the acoustic element 306 may be received by the microphone 312. Furthermore, in one or more embodiments, such acoustic energy may not be dampened or attenuated by the acoustic element.

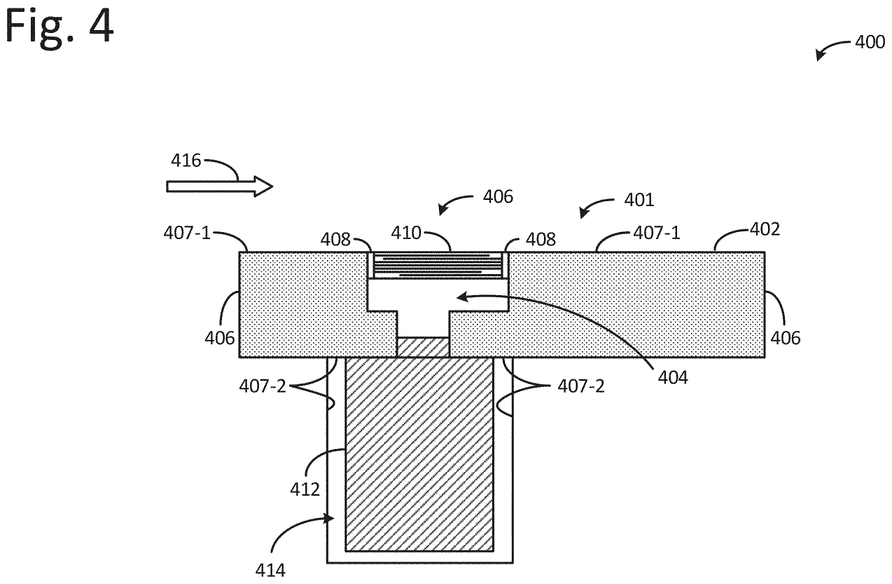

An exemplary schematic partial top-down view of a hearing device 400 that includes an acoustic element 406 is shown in FIG. 4. All of the design considerations and possibilities regarding hearing device 200 of FIGS. 2A-B and hearing device 300 of FIGS. 3A-B apply equally to hearing device 400 of FIG. 4. The hearing device 400 may include a housing 401 (e.g., housing 102 of FIG. 1A), a microphone 412 (e.g., audio sensor 108 of FIG. 1A), and an acoustic element 406.

The housing 401 may include a shell 402 and a microphone port 404. The shell may have an outer surface 407-1 and an inner surface 407-2. The inner surface 407-2 may define a cavity 414 in the housing of the hearing device 400. The shell 402 may include any suitable material or materials such as, for example, plastic, acrylic, silicone, vinyl, polyethylene, nylon, etc. The microphone port 404 may be disposed in the shell 402 between the outer surface 407-1 and the inner surface 407-2. The microphone port 404 may acoustically connect an external environment to the cavity 414. A cross-section of the microphone port 404 may take on any suitable size or shape. The cross-section of the microphone port 404 may be, for example, circular, ovoid, polygonal, etc.

The microphone 412 may be disposed within the cavity 414 and acoustically connected to the microphone port 404. The microphone 412 may include any of the features and qualities of the audio sensor 108 of FIG. 1A.

The acoustic element 406 may be disposed within the microphone port 404. In one or more embodiments, the acoustic element 406 may occlude the microphone port 404. In one or more embodiments, the acoustic element 406 may be insertable and removeable from the microphone port 404. The acoustic element 406 may include any suitable material or materials. In one or more embodiments, the acoustic element 406 includes, for example, a melt-processable thermoset polymer material, an elastomer material, a viscoelastic material, a non-Newtonian material, etc. The acoustic element 406 may include a substrate 408 and fibers 410 extending from the substrate. The substrate 408 and the fibers 410 may be formed separately or monolithically. In one or more embodiments, the substrate 408 and fibers 410 may be formed from the same material or materials. In one or more embodiments, the substrate 408 may include a first material and the fibers 410 may include a second material. In one or more embodiments, the first material may have a hardness value greater than a hardness value of the second material. In other words, the substrate 408 may be more rigid than the fibers 410 and the substrate 408 may define an overall shape of the acoustic element 406.

The substrate 408 may take on any suitable size or shape. In one or more embodiments, the substrate 408 may be shaped to be received in the microphone port. The substrate may be, for example, ring shaped, ovoid shaped, cup shaped, cone shaped, frustoconical shaped, etc. In one embodiment, the acoustic element 406 may include at least one opening disposed through the substrate. Each of the fibers 410 may be attached to the substrate at one end or both ends. The substrate 408 may act as an anchor for the fibers 410. In other words, the fibers 410 may be attached to the substrate 408 and immovable at one end while the other end of the fibers is unattached and free to move. The fibers 410 may include one or more fiber like structures such as, for example, threads, filaments, tendrils, coils, spirals, etc. In one embodiment, at least one fiber of the fibers 410 of the acoustic element 406 includes an aspect ratio of at least 100:1.

The acoustic element 406 may mitigate turbulent air flow at or near the microphone port 404 while being substantially acoustically transparent to acoustic energy. In other words, the acoustic element 406 may mitigate wind generated microphone noise caused by turbulent air flow without substantially attenuating or distorting desired sounds such as, for example, speech, music, ambient noises, laughter, birdsong, or other acoustic energy. As shown, wind may flow in the direction of arrow 416. The acoustic element 406 may mitigate or reduce the incidence of airflow of such wind on the microphone port 404, thereby reducing turbulent air flow at or near the microphone port. However, the acoustic element 406 may not significantly reduce the amplitude of sound waves incident on the microphone port 404. In other words, at least a portion of acoustic energy incident upon the acoustic element 406 may be received by the microphone 412. Furthermore, in one or more embodiments, such acoustic energy may not be dampened or attenuated by the acoustic element.

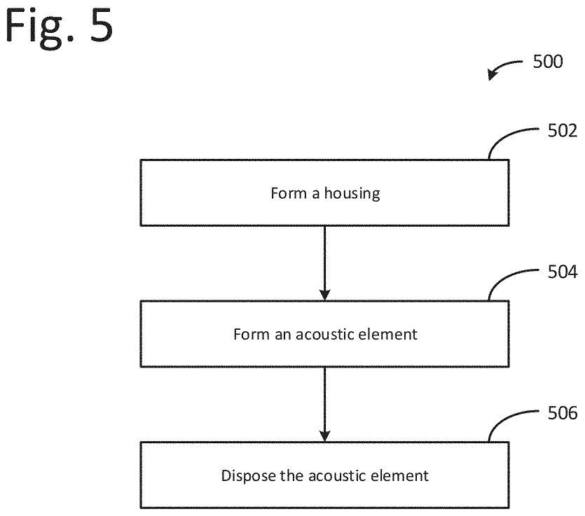

An exemplary schematic flow diagram of an illustrative technique, or process, 500 for making the hearing device 200 is shown in FIG. 5. Although described in regard to hearing device 200 of FIGS. 2A-B, the technique 500 can be utilized to form any suitable hearing device. The technique 500 may include forming the housing including the shell 202 and the microphone port 204 disposed between the outer surface 207-1 of the shell and the inner surface 207-1 of the shell at 502. The housing 201 may be formed using any suitable technique or techniques such as, for example, 3D printing, molding, machining, extrusion, etc.

The technique 500 may include forming the acoustic element 206 that includes the substrate 208 and fibers 210 extending from the substrate at 504. The acoustic element 206 may be formed using any suitable technique or techniques such as, for example, 3D printing, molding, machining, extrusion, etc. In one or more embodiments, forming the acoustic element 206 may include 3D printing the acoustic element. Furthermore, 3D printing the acoustic element may include 3D printing the fibers 210 onto the substrate 208. Alternatively, 3D printing the acoustic element 206 may include 3D printing the fibers 210 and the substrate 208 as a unitary element. In one or more embodiments, 3D printing the acoustic element 206 may include 3D printing the substrate 208 using a first material and 3D printing the fibers 210 onto the substrate using a second material.

The technique 500 may include disposing the acoustic element 206 on the outer surface 207-1 of the shell 202 or at least partially within the microphone port 204 such that at least a portion of acoustic energy incident upon the acoustic element is received by the microphone 212 at 506. The acoustic element 206 may be disposed in various configurations relative to the microphone port 204. In one or more embodiments, disposing the acoustic element 206 includes disposing the acoustic element over the microphone port 204 (e.g., hearing device 300 of FIGS. 3A-B). In one or more embodiments, disposing the acoustic element 206 includes disposing the acoustic element within the microphone port 204 (e.g., hearing device 400 of FIG. 4). In one or more embodiments, disposing the acoustic element 206 includes disposing the acoustic element on the outer surface 207-1 of the housing 201 adjacent to the microphone port as shown in FIGS. 2A-B. The acoustic element 206 may be disposed using any suitable technique or techniques such as, for example, gluing, connecting, 3D printing, bonding, etc. In one or more embodiments, disposing the acoustic element 206 may include 3D printing the acoustic element on the outer surface 207-1 of the shell 202 or at least partially within the microphone port 204.

Exemplary techniques, apparatus, and systems herein provide a hearing device with an acoustic element to mitigate wind generated microphone noise. Acoustic elements as described herein may reduce wind turbulence that impinges on microphone ports while remaining acoustically transparent to acoustic energy.

All references and publications cited herein are expressly incorporated herein by reference in their entirety into this disclosure, except to the extent they may directly contradict this disclosure. Illustrative embodiments of this disclosure are discussed and reference has been made to possible variations within the scope of this disclosure. These and other variations and modifications in the disclosure will be apparent to those skilled in the art without departing from the scope of the disclosure, and it should be understood that this disclosure is not limited to the illustrative embodiments set forth herein. Accordingly, the disclosure is to be limited only by the claims provided below.

1. A hearing device comprising:
a housing comprising a shell and a microphone port disposed between an outer surface of the shell and an inner surface of the shell that defines a cavity within the shell;
a microphone disposed within the cavity of the shell and acoustically connected to the microphone port; and
an acoustic element disposed on the outer surface of the shell or at least partially within the microphone port, wherein the acoustic element comprises a substrate and fibers extending from the substrate;
wherein at least a portion of acoustic energy incident upon the acoustic element is received by the microphone.

2. The hearing device of claim 1, wherein the acoustic element is disposed adjacent to the microphone port.

3. The hearing device of claim 1, wherein the acoustic element is disposed over the microphone port.

4. The hearing device of claim 1, wherein at least one fiber of the fibers of the acoustic element comprises an aspect ratio of at least 100:1.

5. The hearing device of claim 1, wherein the acoustic element further comprises at least one opening disposed through the substrate.

6. The hearing device of claim 1, wherein the acoustic element comprises a 3D printed acoustic element.

7. The hearing device of claim 1, wherein the housing further comprises a custom molded portion.

8. The hearing device of claim 1, wherein at least one fiber of the fibers of the acoustic element is connected to the substrate at both ends of the fiber.

9. The hearing device of claim 1, wherein the acoustic element comprises a melt-processable thermoset polymer material.

10. The hearing device of claim 1, wherein the acoustic element is disposed at least partially within the microphone port.

11. The hearing device of claim 1, wherein the substrate of the acoustic element comprises a first material and the fibers of the acoustic element comprise a second material.

12. The hearing device of claim 11, wherein a hardness value of the first material is greater than a hardness value of the second material.

13. A method comprising:
forming a housing comprising a shell and a microphone port disposed between an outer surface of the shell and an inner surface of the shell, wherein the inner surface of the shell defines a cavity within the shell;
forming an acoustic element that comprises a substrate and fibers extending from the substrate; and
disposing the acoustic element on the outer surface of the shell or at least partially within the microphone port such that at least a portion of acoustic energy incident upon the acoustic element is received by the microphone.

14. The method of claim 13, wherein disposing the acoustic element comprises disposing the acoustic element over the microphone port.

15. The method of claim 13, wherein disposing the acoustic element comprises disposing the acoustic element on the outer surface of the housing adjacent to the microphone port.

16. The method of claim 13, wherein forming the acoustic element comprises 3D printing the acoustic element.

17. The method of claim 16, wherein 3D printing the acoustic element comprises 3D printing the fibers onto the substrate.

18. The method of claim 16, wherein 3D printing the acoustic element comprises 3D printing the fibers and the substrate as a unitary element.

19. The method of claim 16, wherein 3D printing the acoustic element comprises 3D printing the substrate using a first material and 3D printing the fibers onto the substrate using a second material.

20. The method of claim 16, wherein disposing the acoustic element comprises 3D printing the acoustic element on the outer surface of the shell or at least partially within the microphone port.
